(19) United States
(12) Patent Application Publication
(10) Pub. No.: US 2005/0277531 A1
(43) Pub. Date: Dec. 15, 2005

(54) Design-forming sleeve for a rolling pin

(76) Inventor: Douglas J. Schneider, Glen Cove, NY (US)

Correspondence Address: BRIAN ROFFE, ESQ, 11 SUNRISE PLAZA, SUITE 303, VALLEY STREAM, NY, 11580-6170, US

(21) Appl. No.: 10/865,591

(22) Filed: Jun. 10, 2004

(51) Int. Cl. A21C 3/02; B05C 1/08

(52) U.S. Cl. 492/14; 492/19

(57) ABSTRACT

Design-forming sleeve for a rolling pin includes a substantially tubular portion adapted to cover a rolling cylinder of the rolling pin and an annular, substantially planar end portion arranged to engage with an axial edge of the rolling pin. The tubular portion has an outer surface which includes a design to be imprinted into a pastry product. One axial end of the tubular portion is open to enable the tubular portion to be slid onto and off of the rolling cylinder while the end portion is arranged at the opposite axial end of the tubular portion. The end portion includes a central aperture through which one of the handles of the rolling pin passes when the sleeve is arranged on the rolling pin.

### FIELD OF THE INVENTION

The present invention relates to a design-forming sleeve for a rolling pin and to a rolling pin including the same.

### BACKGROUND OF THE INVENTION

In the baking field, it is often desirable to form designs in pastry products, such as fondants, which are then used as outer coverings for cakes and the like. Prior to the formation of the designs, the pastry products are typically rolled to a desired thickness and then the design is imprinted, embossed or imparted into the rolled pastry product.

To this end, rolling pins have been developed which include impressions on the outer surface, the impressions are often inverse to the desired design to be formed in the rolled pastry product. For example, PME Sugarcraft sells a deep impression basketweave rolling pin which includes a tubular rolling cylinder having a rough outer surface with impressions and handles fixed to the rolling cylinder. In use, the baker holds the handles loosely in his hands and exerts pressure to push the handles forward and rotate them thereby causing the rolling cylinder to rotate over a previously rolled pastry product and imprint the basketweave design into the pastry product. This basketweave rolling pin is relatively expensive and is limited to forming only the basketweave pattern and cannot be used as a conventional smooth-surface rolling pin.

PME Sugarcraft also sells a polished stainless steel rolling pin with a protective plastic diamond shape roller sleeve. The roller sleeve is separable from the rolling pin and is formed from a network of interlaced strips of plastic material so that the surface of the rolling pin is exposed even when the roller sleeve is placed on the rolling pin. When the rolling pin with the roller sleeve thereon is rolled over a pastry product, the pastry product is imprinted with the diamond shape while the pastry product comes into contact with the rolling pin.

Another type of rolling pin consists of a substantially cylindrical member which has a rough outer surface with impressions forming a design therein, but does not include any handles. In use, the baker places his finger on the cylindrical member and rolls it over the previously rolled pastry product in order to imprint the design into the pastry product.

There are drawbacks to the above-mentioned prior art rolling pins which form designs in rolled pastry products. For example, each rolling pin can imprint only a single design into the rolled pastry product and if different designs are desired, the baker would have to purchase another rolling pin with each desired design. This can be costly as the number of desired designs can be virtually unlimited and each rolling pin can cost, for example, $50-$75. Moreover, in view of the manufacturing costs for each rolling pin having a different design, only a small number of designs are available, i.e., what the manufacturer believes is the most desirable design.

Another drawback is that the prior art rolling pins described above are formed integral with the design-forming outer surface so that the rolling pins can only be used to form the specific design in the rolled pastry products, and cannot be used for other purposes, i.e., to roll the pastry product to the desired thickness in preparation for the formation of a design therein.

### OBJECTS AND SUMMARY OF THE INVENTION

Accordingly, it is an object of the present invention to provide a new and improved rolling pin which avoids the drawbacks of the prior art rolling pins described above.

It is another object of the present invention to provide a new rolling pin which is capable of forming a design in a rolled pastry product.

It is yet another object of the present invention to provide a new sleeve which can be securely placed onto a rolling pin and enables designs to be formed in rolled pastry products as the covered rolling pin is rolled over the pastry products.

It is still another object of the present invention to provide a new rolling pin which can be used to form a design in rolled pastry products and for other purposes, i.e., it can be used as a conventional rolling pin to roll pastry products to a desired thickness.

In order to achieve these objects and others, a design-forming sleeve for a rolling pin in accordance with the invention includes a substantially tubular portion adapted to cover a rolling cylinder of the rolling pin and an annular, substantially planar end portion arranged to engage with an axial edge of the rolling pin. The tubular portion has an outer surface which includes a design to be imprinted into a pastry product. One axial end of the tubular portion is open to enable the tubular portion to be slid onto and off of the rolling cylinder while the end portion is arranged at the opposite axial end of the tubular portion. The end portion includes a central aperture through which one of the handles of the rolling pin passes when the sleeve is arranged on the rolling pin.

As such, the sleeve can be slid onto the rolling pin when it is desired to imprint a design into a rolled pastry product and removed from the rolling pin in order to use the rolling pin in a conventional manner, e.g., to roll the pastry product to a desired thickness. It is not necessary to have a separate, dedicated rolling pin to enable designs to be formed in rolled pastry products as in the prior art constructions described above. Moreover, the sleeve can be formed from a low cost material so that numerous sleeves with different designs can be manufactured and sold to thereby broaden the possible designs that can be imprinted into rolled pastry products. A large selection of sleeves can be offered to bakers with the bakers being able to select whichever they want. They would not be limited to only those designs which a manufacturer believes will be popular.

### BRIEF DESCRIPTION OF THE DRAWINGS

The following drawings are illustrative of embodiments of the invention and are not meant to limit the scope of the invention as encompassed by the claims.

FIG. 1 is a perspective view of a design-forming sleeve for a rolling pin in accordance with the invention.

FIG. 2 is a side view of a rolling pin having a design-forming sleeve in accordance with the invention.

FIG. 3 is a side view of rolling pin shown in FIG. 2.

FIG. 4 is a cross-sectional view of the rolling pin shown in FIG. 2 taken along the line 4-4 in FIG. 3.

FIG. 5 is a cross-sectional view of the rolling pin shown in FIG. 2 taken along the line 5-5 in FIG. 2.

### DETAILED DESCRIPTION OF THE INVENTION

Referring to the accompanying drawings wherein like reference numerals refer to the same or similar elements, FIG. 1 shows a design-forming sleeve in accordance with the invention which is designated generally as 10 and comprise a tubular portion 12 and an annular, planar end portion 14 arranged at one axial end 12a of the tubular portion 12. The other axial end 12b of the tubular portion 12 is open and exposed to enable the sleeve 10 to be slid onto a rolling pin. Tubular portion 12 has a substantially cylindrical outer surface.

The tubular portion 12 includes a design 16 to be imprinted into a rolled pastry product, or the inverse of a design to be imprinted into a rolled pastry product. The design 16 may include indentations or depressions below the median surface of the tubular portion 12, and projections or raised portions above the median surface, as needed in order to form the desired design. The design shown in FIG. 1 is not meant to limit the invention is any manner and numerous other designs can be formed on the sleeve 10, including for example, a basketweave design.

The planar end portion 14 includes a central aperture 18 through which a handle of a conventional rolling pin passes when the sleeve 10 is slid therein. The size of the aperture 18 can be varied to enable the sleeve 10 to fit variously sized rolling pin. However, the size of the aperture 18 should not be overly large because as much contact as possible between the end portion 14 and the axial edge of the rolling pin to which the sleeve 10 is engaged with is desired. Such contact serves to maintain the relative position between the sleeve 10 and the rolling pin and inhibits axial sliding of the sleeve 10 relative to the rolling pin.

The sleeve 10 is preferably a unitary structure made of plastic by, for example, a blow forming or injection molding process. The plastic from which the sleeve 10 is made can be any type of plastic which can contact food products without adverse consequences and preferably is a durable plastic. When formed from plastic, the thickness of the tubular portion 12 of the sleeve 10 can be in a range from about 1 mm to about 3 mm.

In the illustrated embodiment, the tubular portion 12 of the sleeve 10 is solid, i.e., does not includes any apertures or openings therein. As such, when the sleeve 10 is placed onto a rolling pin and used to imprint a design into a pastry product, the sleeve 10 prevents contact between the rolling pin and the pastry product and thus the pastry product cannot adhere to the rolling pin.

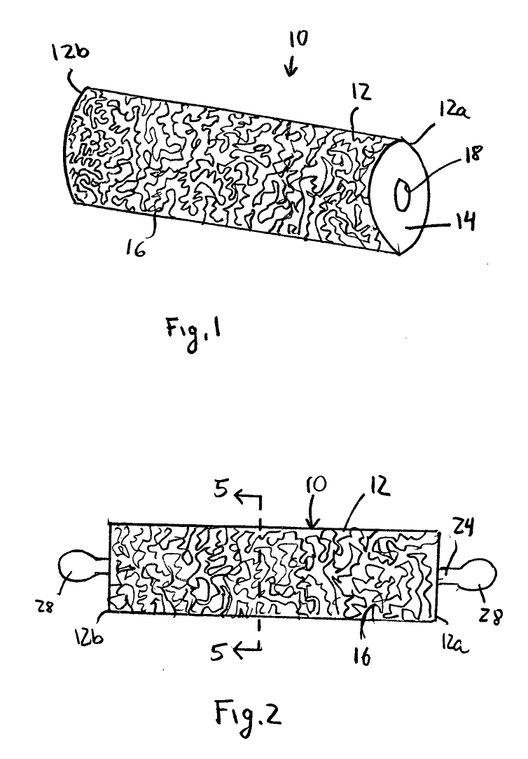

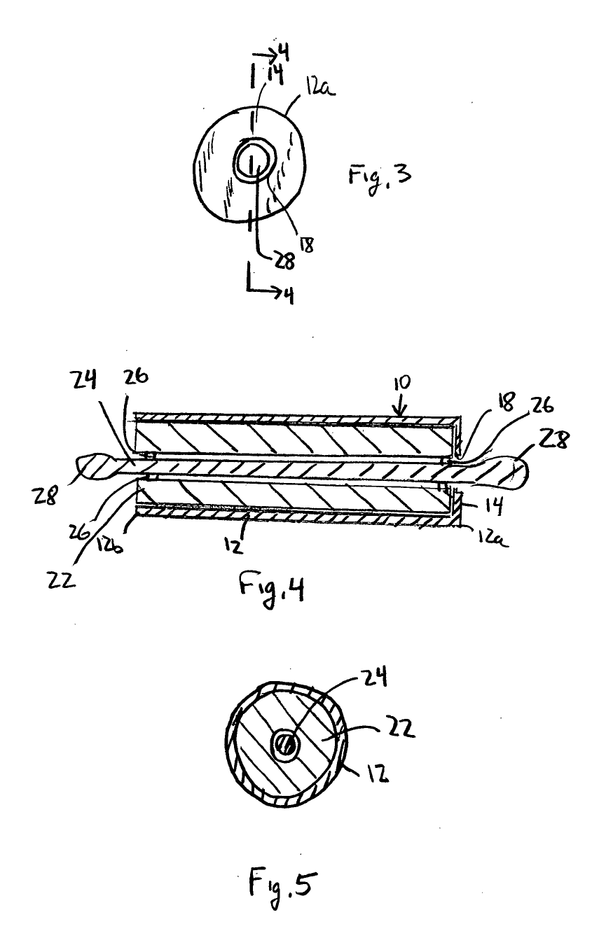

Referring now to FIGS. 2-5, the sleeve 10 is designed to slide onto a rolling pin 20 having a rolling cylinder 22, an axial shaft 24 extending through an interior space of the rolling cylinder 22, bearings 26 for rotatably supporting the rolling cylinder 22 on the axial shaft 24 and handles 28 fixed to or formed integral with the axial shaft 24. One of the handles 28 of the rolling pin 20 passes through the aperture 18 on the planar end portion 14 of the sleeve 10 such that the planar end portion 14 is essentially flush against and in contact with the axial end portion of the rolling cylinder 22 (see FIG. 4). Thus, the aperture 18 is dimensioned to be slightly larger than the maximum width of the handle 28.

To optimize the sleeve 10 for use with the rolling pin 20, the axial length of the sleeve 10 is preferably substantially the same as the axial length of the rolling cylinder 22, whether the rolling cylinder 22 has an axial length of, for example, 6 inches, 9 inches, 12 inches or 18 inches. The inner diameter of the sleeve 10 is substantially the same as the outer diameter of the rolling cylinder 22, and maybe even slightly larger, so that the sleeve 10 slides easily onto and off of the rolling cylinder 22 and is frictionally retained on the rolling cylinder 22 (see FIG. 5).

A multitude of different sleeves 10 could be formed, each with a different design.

In use, a baker would first roll a pastry product to a desired thickness using a conventional, smooth surface rolling pin 20. The baker would then select a sleeve 10 with a desired design 16, and compatible dimensions for the conventional rolling pin, and slide it onto the conventional rolling pin 20. The baker would then push the handles 28 of the rolling pin 20 forward thereby causing the sleeve 10 to rotate over the rolled pastry product and imprint the design 16 into the rolled pastry product. The baker makes a single pass with the rolling pin 20 having the sleeve 10 thereon over the rolled pastry product. Since the handles 28 can be securely grasped as the rolling cylinder 22 and sleeve 10 thereon rotate, the baker can more easily roll the rolling pin 20 over the rolled pastry product.

If the baker then wants to change the design, e.g., to imprint a different design onto a different portion of a cake or for a rolled pastry product for another cake, the baker would simply remove the sleeve 10 from the rolling pin 20 and place another sleeve 10 with a different design onto the rolling pin 20.

Accordingly, the invention provides a baker with the ability to form numerous different designs in rolled pastry products in an easy and inexpensive manner. The cost of each sleeve 10 is considerably less than the costs of a new rolling pin. Moreover, the baker can use existing rolling pins in combination with the sleeve in accordance with the invention so that new rolling pins do not have to be purchased and the same rolling pin can be used for both rolling the pastry product to the desired thickness and, once a sleeve is attached, to form a design in the rolled pastry product.

While particular embodiments of the invention have been shown and described, it will be obvious to those skilled in the art that changes and modifications may be made without departing from the invention in its broader aspects, and, therefore, the aim in the appended claims is to cover all such changes and modifications as fall within the true spirit and scope of the invention.

1. A design-forming sleeve for a rolling pin having an axial shaft, a rolling cylinder arranged around the axial shaft and rotatably supported on the axial shaft and handles fixed to or formed integral with the axial shaft, comprising:
a substantially tubular portion adapted to cover the rolling cylinder, said tubular portion having an outer surface including a design to be imprinted into a pastry product and first and second opposed axial ends, said first axial end of said tubular portion being open to enable said tubular portion to be slid onto and off of the rolling cylinder; and
an annular, substantially planar end portion arranged at said second axial end of said tubular portion, said end portion including a central aperture through which one of the handles of the rolling pin passes when the sleeve is arranged on the rolling pin.

2. The sleeve of claim 1, wherein said outer surface includes depressions below a median surface of said tubular portion.

3. The sleeve of claim 1, wherein said outer surface includes raised projections above a median surface of said tubular portion.

4. The sleeve of claim 1, wherein said tubular portion is integrally formed with said end portion.

5. The sleeve of claim 1, wherein said tubular portion has a thickness of from about 1 mm to about 3 mm.

6. The sleeve of claim 1, wherein said tubular portion is solid.

7. A rolling pin for imprinting a design into pastry products, comprising:
an axial shaft;
a rolling cylinder arranged around said axial shaft and rotatably supported on said axial shaft such that said rolling cylinder is rotatable while said axial shaft is stationary;
handles fixed to or formed integral with opposed sides of said axial shaft; and
a sleeve including a substantially tubular portion arranged on said rolling cylinder, said tubular portion having an outer surface including a design to be imprinted into a pastry product.

8. The rolling pin of claim 7, wherein said tubular portion has first and second opposed axial ends, said first axial end of said tubular portion being open to enable said tubular portion to be slid onto and off of said rolling cylinder.

9. The rolling pin of claim 8, wherein said sleeve further comprises an annular, substantially planar end portion arranged at said second axial end of said tubular portion, said end portion including a central aperture through which one of said handles extends.

10. The rolling pin of claim 9, wherein said tubular portion is integrally formed with said end portion.

11. The rolling pin of claim 9, wherein said sleeve is arranged such that an inner surface of said tubular portion frictionally engages an outer surface of said rolling cylinder.

12. The rolling pin of claim 11, wherein said sleeve is arranged such that an inner surface of said end portion frictionally engages an axial surface of said rolling cylinder.

13. The rolling pin of claim 9, wherein said sleeve is arranged such that an inner surface of said end portion frictionally engages an axial surface of said rolling cylinder.

14. The rolling pin of claim 7, wherein said outer surface includes depressions below a median surface of said tubular portion.

15. The rolling pin of claim 7, wherein said outer surface includes raised projections above a median surface of said tubular portion.

16. The rolling pin of claim 7, wherein said tubular portion has a thickness of from about 1 mm to about 3 mm.

17. The rolling pin of claim 7, wherein said sleeve is arranged such that an inner surface of said tubular portion frictionally engages an outer surface of said rolling cylinder.

18. The rolling pin of claim 7, wherein said tubular portion is solid.
